(19) United States
(12) Patent Application Publication
(10) Pub. No.: US 2024/0249532 A1
(43) Pub. Date: Jul. 25, 2024

(54) DRIVING ASSISTANCE DEVICE

(71) Applicant: TOYOTA JIDOSHA KABUSHIKI KAISHA, Toyota-shi (JP)

(72) Inventor: Hiroaki ITO, Nisshin-shi (JP)

(73) Assignee: TOYOTA JIDOSHA KABUSHIKI KAISHA, Toyota-shi (JP)

(21) Appl. No.: 18/494,110

(22) Filed: Oct. 25, 2023

(30) Foreign Application Priority Data
Jan. 19, 2023 (JP) 2023-006669

(51) Int. Cl. G06V 20/58

(52) U.S. Cl. CPC G06V 20/582

(57) ABSTRACT

The driving assistance device includes a processor, and the processor acquires image data captured by an in-vehicle camera provided in a vehicle, detects road signs from the image data, and detects road signs from a plurality of pre-registered existing designs of road signs. If it is determined that the road sign is different from a plurality of existing designs, the corresponding candidate road sign is presented to the user based on the road sign and the existing design.

### CROSS-REFERENCE TO RELATED APPLICATION

This application claims priority to Japanese Patent Application No. 2023- 006669 filed on Jan. 19, 2023, incorporated herein by reference in its entirety.

### BACKGROUND

### 1. Technical Field

The present disclosure relates to a driving assistance device.

### 2. Description of Related Art

Japanese Unexamined Patent Application Publication No. 2012-164254 (JP 2012-164254 A) discloses a technique of determining, when a road sign is recognized from image data acquired by an in-vehicle camera, whether the recognized road sign is a fixed sign or a temporary sign based on the position at which the road sign is detected and map data.

### SUMMARY

However, JP 2012-164254 A involves a problem that a road sign cannot be correctly detected or the content of a road sign cannot be recognized when the design of the road sign has been renewed or when an unregistered road sign is recognized.

The present disclosure has been made in view of the above, and has an object to provide a driving assistance device that can accurately detect even a road sign with a new design.

In order to solve the above problem and achieve the object, a driving assistance device according to the present disclosure is a driving assistance device including a processor, in which the processor is configured to:
acquire image data captured by an in-vehicle camera provided on a vehicle;
detect a road sign from the image data;
determine whether the road sign is different from a plurality of existing designs registered in advance; and

present a candidate for the road sign to a user based on the road sign and the existing designs when it is determined that the road sign is different from the existing designs.

The present disclosure achieves the effect that even a road sign with a new design can be accurately detected.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the functional configuration of a vehicle according to a first embodiment;

FIG. 2 is a diagram for explaining conventional problems;

FIG. 3 is a diagram for explaining another conventional problem;

FIG. 4 is a flowchart showing an outline of processing executed by the driving assistance device according to the first embodiment;

FIG. 5 is a diagram showing an example of a display screen displayed by the display unit; and

FIG. 6 is a block diagram of a functional configuration of a server according to the second embodiment;

### DETAILED DESCRIPTION OF EMBODIMENTS

A vehicle equipped with a driving assistance device according to an embodiment of the present disclosure will be described below with reference to the drawings.

It should be noted that the present disclosure is not limited by the following embodiments.

Also, the same parts are denoted by the same reference numerals in the following description.

### First Embodiment

### Vehicle Overview

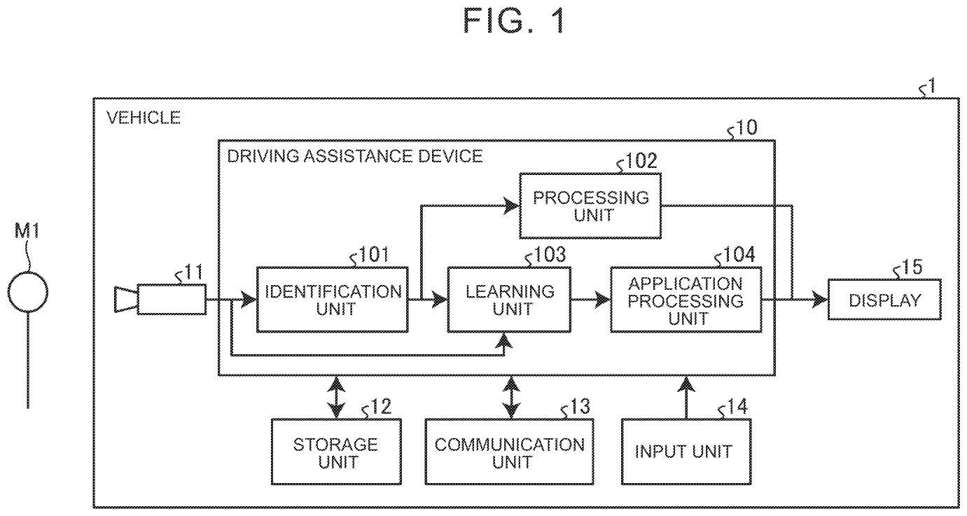

FIG. 1 is a block diagram showing the functional configuration of a vehicle according to a first embodiment. The vehicle shown in FIG. 1 is assumed to be a Hybrid Electric Vehicle (HEV), a Plug-in Hybrid Electric Vehicle (PHEV), a Battery Electric Vehicle (BEV), a Fuel Cell Electric Vehicle (FCEV), or the like. Of course, the vehicle 1 maybe automatically operable or manually operable. The vehicle 1 includes a driving assistance device 10, an in-vehicle camera 11, a storage unit 12, a communication unit 13, an input unit 14 and a display unit 15.

The driving assistance device 10 controls driving of the vehicle 1 and the like. The driving assistance device 10 is realized using a processor having hardware. The hardware includes, for example, a communication interface, memory, Central Processing

Unit (CPU), Digital Signal Processor (DSP) and Field-Programmable Gate Array (FPGA). A detailed functional configuration of the driving assistance device 10 will be described later.

One or more in-vehicle cameras 11 are provided in the vehicle 1. Under the control of the driving assistance device 10, the in-vehicle camera 11 captures the exterior and vehicle cabin of the vehicle 1 to generate image data including the road sign M1 at a predetermined frame rate. The in-vehicle camera 11 is configured using a Charge Coupled Device (CCD) image sensor, a Complementary Metal Oxide Semiconductor (CMOS) image sensor, or the like.

The storage unit 12 is configured using Dynamic Random Access Memory (DRAM), Read Only Memory (ROM), Hard Disk Drive (HDD), Solid State Drive (SSD), and the like. The storage unit 12 stores various programs executed by the driving assistance device 10, identifiers and learned models for the driving assistance device 10 to detect (recognize) road signs from image data, and the like.

The communication unit 13 communicates with the outside according to a predetermined communication standard. Here, it is assumed that the predetermined communication standard includes, for example, Internet network, Wi-Fi, Bluetooth (registered trademark), mobile phone network, and the like. The communication unit 13 is configured using a communication module or the like having an antenna or the like.

The input unit 14 receives a user's operation input and outputs the content according to the received operation to the driving assistance device 10. The input unit 14 is configured using buttons, switches, a touch panel, a jog dial, and the like.

The display unit 15 displays various information input from the driving assistance device 10. The display unit 15 is configured using a liquid crystal display, an organic electroluminescent display, or the like.

### Detailed Configuration of the Driving Assistance Device

Next, a detailed functional configuration of the driving assistance device 10 will be described. The driving assistance device 10 includes an identification unit 101, a processing unit 102, a learning unit 103 and an application processing unit 104.

The identification unit 101 acquires image data from the in-vehicle camera 11 and detects road signs from the acquired image data. The identification unit 101 also determines whether the road sign detected from the image data is different from a plurality of pre-registered existing designs stored in the storage unit 12.

The processing unit 102 causes the display unit 15 to display the road sign identified by the identification unit 101. Specifically, the processing unit 102 causes the display unit 15 to display an image and characters corresponding to the road sign identified by the identification unit 101.

The learning unit 103 learns, based on the road signs detected from the image data by the identification unit 101, the existing design of the road signs stored in the storage unit 12, the learned model, and the image data input from the in-vehicle camera 11, the road signs detected by the identification unit 101 as new design candidates. In this case, the input data are road signs, marks, symbols, characters, and the like detected by the identification unit 101 from the image data. The output data is a road sign with a new design. The method of constructing a trained model used in the learning unit 103 is not particularly limited, and various machine learning methods such as deep learning using neural networks, support vector machines, decision trees, naive Bayes, and k nearest neighbors. can be used.

The application processing unit 104 proposes a new design by displaying the learning result learned by the learning unit 103 as a new design on the display unit 15.

### Conventional Issues

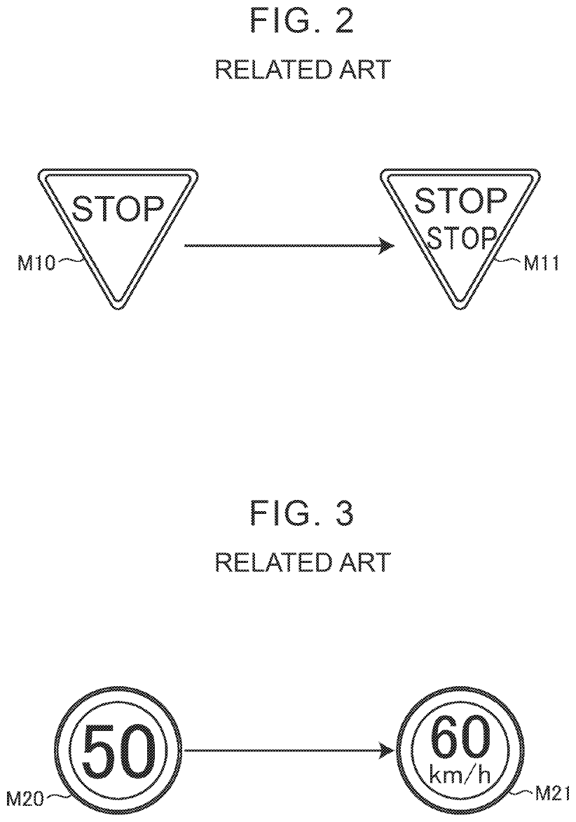

Next, details of conventional problems will be described. FIG. 2 is a diagram for explaining a conventional problem. FIG. 3 is a diagram for explaining another conventional problem.

As shown in FIG. 2, in the conventional identification system, in addition to the pre-registered design road sign M10, a new design road sign M11 may become popular. For example, in recent years, new characters are being included as the characters on road signs are developed into multiple languages in accordance with national policies and the like. For this reason, conventionally, it has been impossible to automatically identify the new design road sign M11. In this case, in the conventional identification system, every time a new design comes out, the user has to bring the vehicle to the dealer to register the new design, which is troublesome.

Further, as shown in FIG. 3, the conventional identification system is compatible only with the road sign M20 designed in the home country, but cannot be compatible with the road sign M21 designed in the neighboring country. In this case, in conventional identification systems, the design and content of road signs had to be registered for each country.

### Processing of Driving Assistance Devices

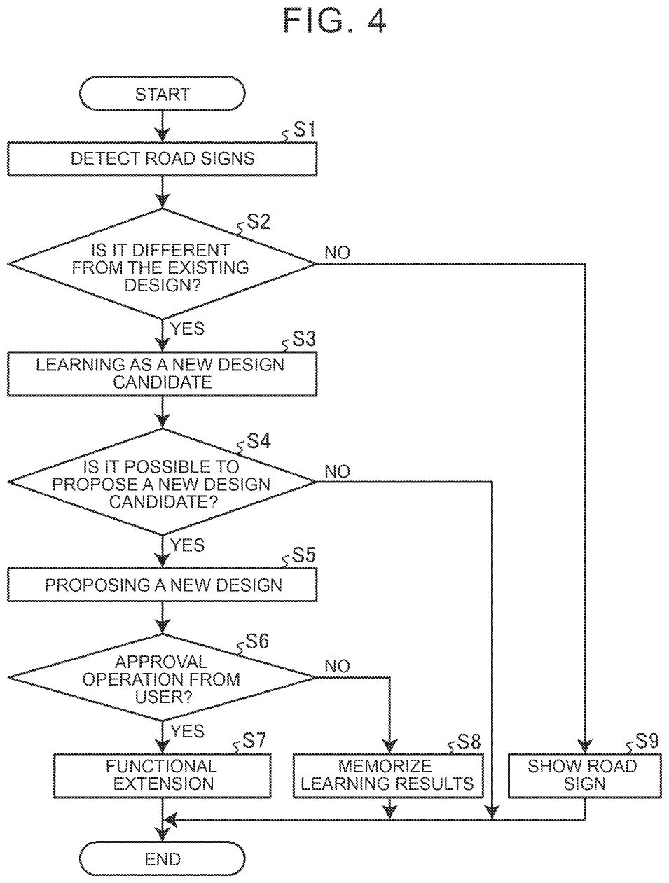

Next, processing executed by the driving assistance device 10 will be described. FIG. 4 is a flowchart showing an overview of the process executed by the driving assistance device 10. As shown in FIG. 4, the identification unit 101 acquires image data from the in-vehicle camera 11 and detects road signs from the acquired image data (S1). In this case, the identification unit 101 detects (recognizes) the shape, color and characters of the road sign according to the identifier stored in the storage unit 12. Of course, the identification unit 101 may detect road signs from image data using well-known template matching.

Subsequently, the identification unit 101 determines whether the road sign detected from the image data is different from a plurality of pre-registered existing designs stored in the storage unit 12 (S2). Specifically, after calculating the degree of matching for each road sign and existing design, the identification unit 101 determines whether the degree of matching with all the existing designs is equal to or less than a predetermined value. If the degree of matching between the road sign and every existing design is equal to or less than a predetermined value, the identification unit 101 determines that the road sign detected from the image data is different from the plurality of pre-registered existing designs stored in the storage unit 12. That is, the identification unit 101 determines that the road sign does not correspond to the existing design. On the other hand, if the degree of matching between the road sign and all the existing designs is not equal to or less than the predetermined value, the road sign detected from the image data and the plurality of pre-registered existing designs stored in the storage unit 12 must be different. That is, the identification unit 101 determines that the road sign detected from the image data corresponds to the existing design. When the identification unit 101 determines that the road sign detected from the image data is different from the plurality of pre-registered existing designs stored in the storage unit 12 (S2: Yes), the driving assistance device 10 proceeds to S3. On the other hand, when the identification unit 101 determines that the road sign detected from the image data does not differ from the plurality of pre-registered existing designs stored in the storage unit 12 (S2: No), the driving assistance device 10 proceeds to S9.

In S3, the learning unit 103 learns, the road signs detected by the identification unit 101 from the image data, the existing design of the road signs stored in the storage unit 12, and the image data input from the in-vehicle camera 11, the road signs that have been detected by the identification unit 101 as new design candidates.

Subsequently, the learning unit 103 determines whether a new design candidate can be proposed (S4). Specifically, the learning unit 103 determines whether the learning result can be proposed as a new design candidate based on the road signs detected from the image data by the identification unit 101, the existing designs of the road signs stored in the storage unit 12, and the image data input from the identification unit 101. When the learning unit 103 determines that a new design candidate can be proposed (S4: Yes), the driving assistance device 10 proceeds to S5. On the other hand, if the learning unit 103 determines that the new design candidate cannot be proposed (S4: No), the driving assistance device 10 ends this process.

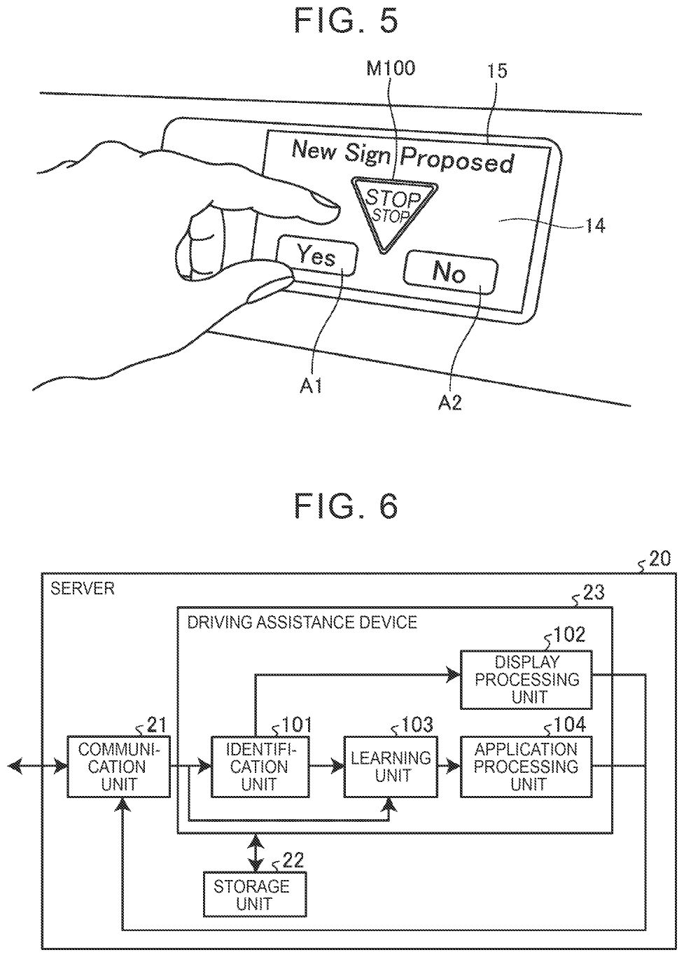

In S5, the application processing unit 104 proposes a new design by displaying the learning result learned by the learning unit 103 as a new design on the display unit 15. FIG. 5 is a diagram showing an example of a display screen displayed by the display unit 15. As shown in FIG. 5, the application processing unit 104 displays on the display unit 15 various image information including the new design M100, the approval icon A1, and the denial icon A2, which are the learning results of the learning unit 103. The approval icon A1 is an icon that receives an operation input for registering the new design M100. The denial icon A2 is an icon that receives an operation input for refusing registration of the new design M100. In FIG. 5, the application processing unit 104 displays the approval icon A1 and the denial icon A2 for the new design M100, but may display the approval icon A1 and the denial icon A2 for each of the shape, the color, and the character included in the new design M100 without limiting to this. Accordingly, the application processing unit 104 can allow the user to confirm in detail the rules and meanings of the road sign of the new design M100.

Subsequently, when the user performs an approval operation for the new design via the input unit 14 (S6: Yes), the application processing unit 104 registers the new design as a road sign in the storage unit 12, thereby expanding the function of the road sign identified by the identification unit 101 (S7). After S7, the driving assistance device 10 ends this process. In response to this, the application processing unit 104 stores the learning result of the learning unit 103 as a learning history in the storage unit 12 (S8). After S8, this process ends.

In S9, the processing unit 102 causes the display unit 15 to display the road sign identified by the identification unit 101. After S9, the driving assistance device 10 terminates this process.

According to the first embodiment described above, the application processing unit 104 proposes a new design by displaying the learning result learned by the learning unit 103 as a new design on the display unit 15. Even road signs can be extended so that they can be detected accurately.

Further, according to the first embodiment, when the user performs an approval operation for a new design via the input unit 14, the application processing unit 104 registers the new design in the storage unit 12 as a road sign. Since the function of the road sign identified by the identification unit 101 is expanded, the learning unit 103 can suppress erroneous learning due to the confirmation operation of the user.

Moreover, according to the first embodiment, since the identification unit 101 detects the shape, color, and characters of the road sign, it is possible to accurately detect the content of the road sign.

Further, according to the first embodiment, since the learning unit 103 learns the detection results of detecting the shapes, colors, and characters of road signs, it is possible to accurately learn even the details of newly designed road signs.

In the first embodiment, the application processing unit 104 proposes a new design by displaying the learning result learned by the learning unit 103 as a new design on the display unit 15, but the present disclosure is not limited to this, and the new design may be proposed to the portable terminal or the like of the user who owns the vehicle 1 via the communication unit 13.

Further, in the first embodiment, the application processing unit 104 proposes a new design to the display unit 15 at the timing when the learning result learned by the learning unit 103 can be proposed as a new design. A new design may be proposed, for example, at a predetermined timing, without having to do so. Here, the predetermined timing means the timing when the injection of the vehicle 1 is turned off, the timing when the vehicle 1 is stopped in a parking lot or the like, the timing when the injection of the vehicle 1 is turned on, and the timing when the vehicle 1 is switched to the automatic driving mode.

### Second Embodiment

Next, a second embodiment will be described. In the first embodiment, the vehicle 1 is provided with the driving assistance device 10, but in the second embodiment, the driving assistance device is provided in a server that can communicate with the vehicle 1 via a network.

### Server Functional Configuration

FIG. 6 is a block diagram of a functional configuration of a server according to the second embodiment. The server 20 shown in FIG. 2 includes a communication unit 21, a storage unit 22 and a driving assistance device 23.

The communication unit 21 communicates with the vehicle according to a predetermined communication standard. Here, the predetermined communication standard is assumed to be composed of, for example, the Internet line network, mobile phone line network, and the like. The communication unit 21 is configured using a communication module or the like having an antenna or the like.

The storage unit 22 is configured using DRAM, ROM, HDD, SSD, and the like. The storage unit 12 stores various programs executed by the driving assistance device 23, identifiers and learned models for the driving assistance device 23 to recognize road signs from image data, and the like.

The driving assistance device 23 transmits various information to the vehicle via the communication unit 21 and acquires various information from the vehicle.

The driving assistance device 23 is realized using a processor having hardware. The hardware includes, for example, a communication interface, memory, CPU, DSP and FPGA.

The driving assistance device 23 has the same functions as the driving assistance device 10 of the first embodiment. Specifically, the driving assistance device 23 includes an identification unit 101, a processing unit 102, a learning unit 103 and an application processing unit 104. In this case, the driving assistance device 23 acquires image data from an external vehicle via the communication unit 21 and detects road signs from the acquired image data. Then, the driving assistance device 23 transmits information about the detected road sign to the vehicle 1 via the communication unit 21. In this case, in the vehicle 1, the display unit 15 displays the newly designed road sign or the like via the communication unit 13. That is, the driving assistance device 23 performs the same processing as the driving assistance device 10 according to the first embodiment. Therefore, a detailed description of the processing executed by the driving assistance device 23 is omitted.

According to the second embodiment described above, as in the first embodiment, it is possible to extend the system so that even a road sign with a new design can be accurately detected.

### Other Embodiments

Further, although the driving assistance devices according to the first and second embodiments are provided in the vehicle or the server, the functions of the driving assistance device may be implemented separately in the server and the vehicle.

Further, in the driving assistance devices according to the first and second embodiments, the above-described “unit” can be read as “means” or “circuit”. For example, the processing unit can be read as processing means or a processing circuit.

Further, the program to be executed by the driving assistance device according to the first and second embodiments is file data in an installable format or an executable format, and can be stored on a CD-ROM, a flexible disk (FD), a CD-R, a Digital

Versatile Disk (DVD), a USB medium, a flash memory, or other computer-readable recording medium.

In addition, in the description of the flowchart in this specification, expressions such as “first”, “after”, and “following” are used to clearly indicate the anteroposterior relationship of the processing between steps. The order of processing required to do so is not uniquely determined by those representations. That is, the order of processing in the flowchart charts described herein may be changed within a consistent range.

Further effects and modifications can be easily derived by those skilled in the art. The broader aspects of the disclosure are not limited to the specific details and representative embodiments shown and described above. Accordingly, various changes may be made without departing from the spirit or scope of the general inventive concept defined by the appended claims and equivalents thereof.

As described above, some of the embodiments of the present application have been described in detail with reference to the drawings. It is possible to carry out the present disclosure in other forms with modifications and improvements.

What is claimed is:

1. A driving assistance device comprising a processor, wherein the processor is configured to:
acquire image data captured by an in-vehicle camera provided on a vehicle;
detect a road sign from the image data;
determine whether the road sign is different from a plurality of existing designs registered in advance; and
present a candidate for the road sign to a user based on the road sign and the existing designs when it is determined that the road sign is different from the existing designs.

2. The driving assistance device according to claim 1, wherein the processor is configured to register the road sign when the user performs an approval operation to approve the candidate for the road sign.

3. The driving assistance device according to claim 2, wherein the processor is configured to detect at least a shape, a color, and characters of the road sign.

4. The driving assistance device according to claim 3, wherein the processor is configured to learn a detection result of detecting the shape, the color, and the characters of the road sign, and output a learning result of learning the detection result.
